(19) United States
(12) Patent Application Publication
(10) Pub. No.: US 2025/0118282 A1
(43) Pub. Date: Apr. 10, 2025

(54) SYSTEMS AND METHODS FOR SOUND ABSORBERS

(71) Applicant: Hykso Inc., Costa Mesa, CA (US)

(72) Inventor: Doug Hoang, Costa Mesa, CA (US)

(73) Assignee: Hykso Inc., Costa Mesa, CA (US)

(21) Appl. No.: 18/377,293

(22) Filed: Oct. 5, 2023

(51) Int. Cl. G10K 11/168; A63B 69/22

(52) U.S. Cl. CPC G10K 11/168; A63B 69/22

(57) ABSTRACT

Systems and methods for sound absorbers provide sound-insulation and reduce unwanted noise and other undesirable side-effects associated with existing training equipment such as punching bags. To this end, an encasing that comprises a sound-absorbing material is wrapped around the training equipment, such that, in response to the encasing being struck, the resulting sound is significantly dampened relative to existing designs. Advantageously, this allows for relatively quiet use of the training equipment and makes it suitable for home installations.

### A. Technical Field

The present disclosure relates generally to noise reduction techniques. More particularly, the present disclosure relates to noise reduction techniques for training equipment such as punching bags.

### B. Background

Physical fitness equipment such as punching bags help users develop and hone a variety of striking skills through practice that involves repeatedly striking a relatively hard surface that results in conditioning and strengthening muscles, tendons, and bones of a user's hands, feet, or limbs. Such exercise bags come in different sizes, shapes, and structures, including self-supporting free-standing bags that are suspended above a floor or rest on the floor. Increasingly, usage of such equipment is transitioning from a gym environment to a home or other location this supporting a more flexible workout routine.

One major shortcoming of conventional bag designs, such as those used in martial arts-type applications, is that their target surface, which is typically fabricated from a plastic material, creates audible noise in response to a punch or a kick being applied to the bag. While in a gym environment such loud operation resulting from traditional designs may not bother individuals near the equipment who may, in fact, draw motivation from hearing such sounds, loud fitness equipment is less desirable for deployments in homes where such sounds produced by the equipment may be perceived as unwelcome and disturbing to others. Transitioning these types of training equipment to accommodate home installations thus presents certain challenges.

Accordingly, it would be desirable to have systems and methods that overcome the above-mentioned limitations and provide training equipment that has improved acoustic performance and is, thus, more suitable for home use.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 depicts a side view of a commonly available punching bag assembly.

FIG. 2 depicts a perspective view of a training bag assembly, according to various embodiments of the present disclosure.

FIG. 3 depicts an exploded view of a sound dampening sleeve assembly, according to various embodiments of the present disclosure.

FIG. 4 depicts a cross section of a sound dampening sleeve assembly, according to various embodiments of the present disclosure.

FIG. 5 is a flowchart of an illustrative process for making a sound dampening sleeve assembly in accordance with various embodiments of the present disclosure.

FIG. 6 is a flowchart of an illustrative process for using a sound dampening sleeve assembly in accordance with various embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporated by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

Furthermore, it shall be noted that embodiments described herein are given in the context of punching bags for martial arts, but one skilled in the art shall recognize that the teachings of the present disclosure are not limited since a training bag may be used by any person who physically strikes a training bag using a body part or object, such as a tool, weapon, or other instrument. Therefore, the disclosure encompasses applications that do not need necessarily be related to martial arts applications, i.e., various embodiments may equally be used in other contexts.

In this document the term “training bag” and “punching bag” refer to a practice device that serves as a target to which a force is applied, e.g., for practicing martial arts or other activities. The term “plastic” includes any elastomer recognized by one of skilled in the art.

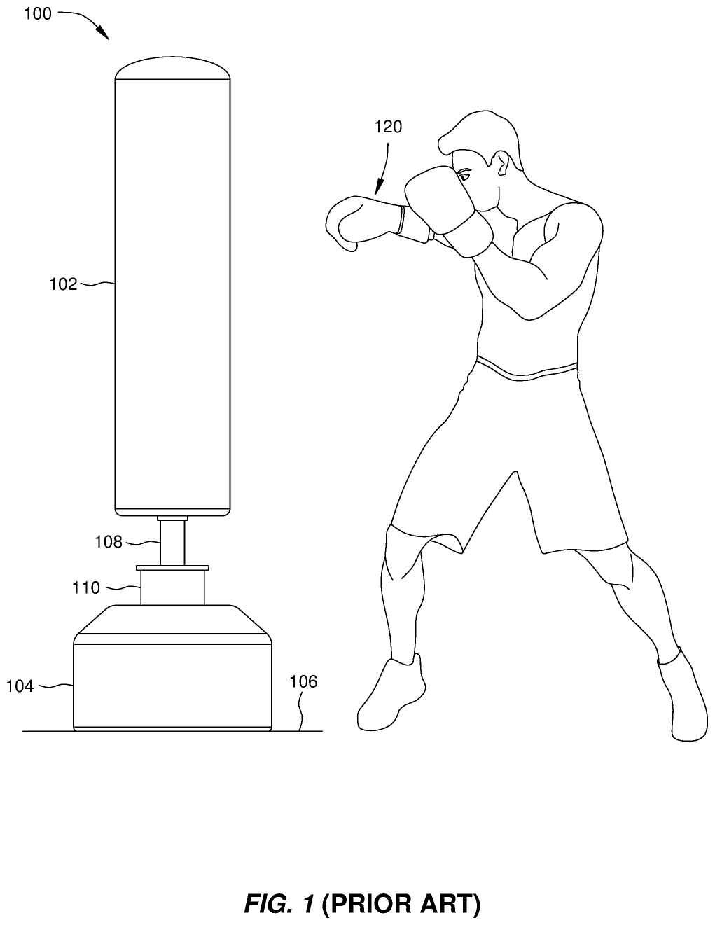

FIG. 1 depicts a side view of a commonly available punching bag assembly. Punching bag assembly 100 comprises top portion 102 having a cylindrical shape, shaft 108, and base 104 that rests on floor 106. As shown in FIG. 1, shaft extends from top portion top 102 and is coupled to base 104 by coupling means 110. The resulting combined structure acts as a relatively rigid single body having a greatly uneven mass distribution along its axis (not shown).

Top portion 102 of punching bag assembly 100 typically consists of some type of cushioning material, e.g., a foam body encapsulated by a vinyl cover. Base 104 is typically fillable with filling material, e.g., through a relatively small opening port into which the user pours sand or water. More sophisticated equipment comprises feedback sensors, such as motion trackers and other measurement devices (not shown).

In operation, once a user applies a force in the form of kinetic energy to an area of top portion 102, e.g., by a strike or kick with object 120, shaft 108 that extends through top portion 102 will transform that force, at least in part, into angular momentum resulting in a rotational force. The rotational force will accelerate top portion 102 away from object 120 due to a torque.

Typically, the amount of lift is proportional to the force exerted on punching bag assembly 100. Once the force applied to top portion 102 is released, top portion 102 will resume its original position. As an undesirable side-effect, unwanted noise is generated each time top portion 102 experiences a relatively strong punch. This shortcoming makes existing training bag designs, such as punching bag assembly 100, unsuitable for use in certain home environments.

In contrast, embodiments herein advantageously provide sound dampening sleeve systems and methods that improved the acoustic performance of the training equipment and, thus, allow installations and use in home environments. Various embodiments accomplish this by employing a sound dampening sleeve assembly that significantly reduces noise when compared to conventional training bag designs.

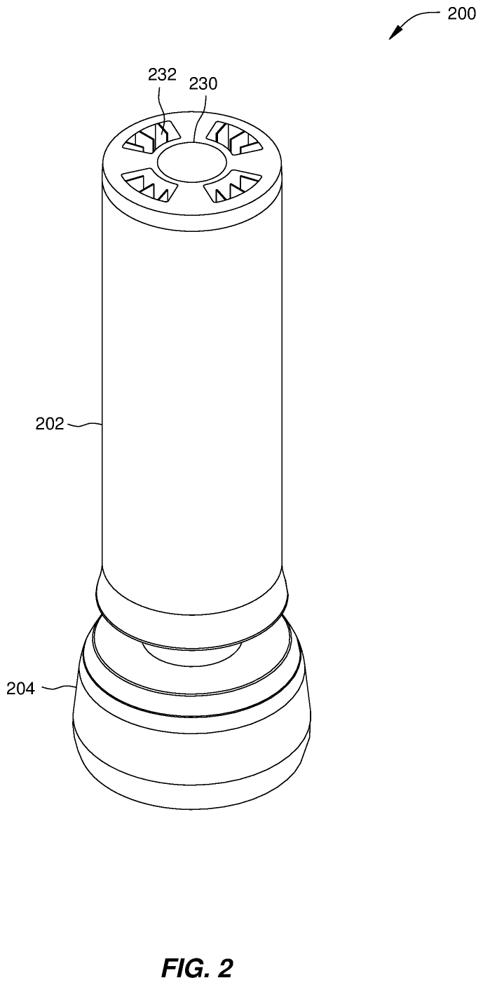

FIG. 2 is a perspective view of a training bag assembly according to various embodiments of the present disclosure. In embodiments, training bag assembly 200 comprises top portion 202 and base 204. Top portion 202 may comprise any suitable durable material, such as plastic, nylon, polycarbonate that has high-impact resistance, high elasticity, and other desirable mechanical and/or chemical properties. Suitable properties include mechanical and acoustic damping, elasticity, and a lack of hysteresis effects. As an example, top portion 202 may comprise a relatively rigid polymer material, such as a thermoplastic elastomer, e.g., thermoplastic polyurethane (TPU) that may be combined with resilient foam material to provide additional padding to top portion 202. Such polymers may be advantageously implemented into a striking area of top portion 202 to dissipate energy during operation. In embodiments, ribs (e.g., 232) may be spaced from each at a predetermined distance along the inner perimeter of structure 202 and may support a filling material within top portion 202.

In embodiments, base 204 may be produced from, e.g., a blow-molded plastic material, such as high-density polyethylene, to create a “hollow” enclosure that can hold a liquid, a gel, or any other suitable filling material or combination thereof. In operation, base 204 may be as a ballast that counterbalances the forces applied to top portion 202. For liquid or gel-like filling materials (e.g., elastomers), some, or all of base 204 may be hermetically sealed to prevent undesirable leakage.

In embodiments, structure 230 in FIG. 2 is a rigid or semi-rigid support structure that allows filling material, e.g., foam/padding made of relatively rigid polymer material, within top portion 202 to be in place and/or compressed, e.g., to reduce its volume and, thus, reduce shipping expenses. Structure 230, which supports the foam/padding, provides structural integrity, and maintains its shape when top portion 202 is vacuum sealed, may be manufactured by using an extrusion process. However, this is not intended a limitation on the scope of the present disclosure since other techniques such as, for example, plastic injection molding process, etc., may be used.

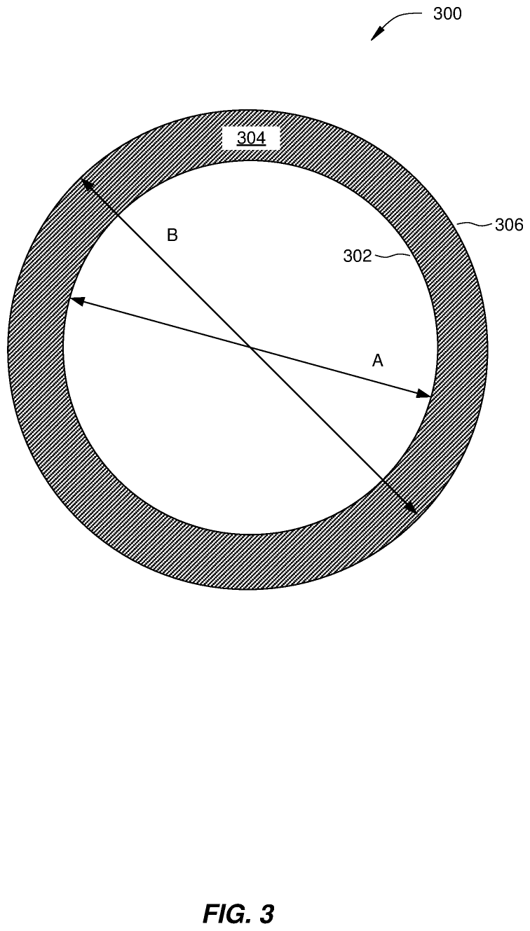

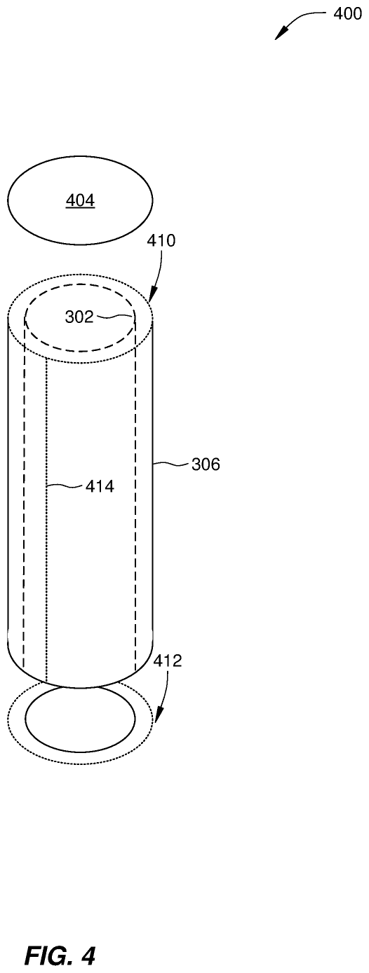

FIG. 3 depicts a cross section of a sound dampening sleeve assembly, according to various embodiments of the present disclosure. FIG. 4 is an exploded view of a sound dampening sleeve assembly, according to various embodiments of the present disclosure. As depicted in FIG. 3, the sound dampening sleeve assembly may comprise inner layer 302 having a diameter “A” and outer layer 306 having diameter “B” that oppositely face each other and that are separated by filler material 304.

In embodiments, filler material 304, which may be an intermediate layer located between inner layer 302 and outer layer 306, may comprise one or more air gaps that aid in reducing the transmission of sound waves produced when the outer surface of outer layer 306 is struck. Such air gaps may be provided by filler material 304 in the form of a thick, e.g., 3 mm-1″ thick, low-density fleece material, or a low-density foam material having microporous voids or air gaps.

In embodiments, as shown in FIG. 4, sound dampening sleeve assembly 400 may further comprise top layer 404 and oppositely facing bottom layer 412 portions that are substantially parallel to each other, spaced apart by the length of outer layer 306. Top and bottom layers 404, 412 may be constructed from stretchable material, such as stretchable fabric. In embodiments, some or all parts of sound dampening sleeve assembly 400 may be sewn to each other using, e.g., heavy-duty polyester of nylon thread and a sufficiently large needle size, such as 16/100 or 1/100. Further, seams 410-414 may be reinforced, e.g., as flat felled seams.

In embodiments, outer layer 306, top layer 404, and bottom layer 412 portions may be made of polyester, cotton, leather, or a combination thereof. Ideally, the used material is durable, can withstand pilling, and exhibits a high resistance to abrasion. In embodiments, outer layer 306, top layer 404, and bottom layer 412 may adhere to various known specifications, such as ISO 12945-2 for pilling resistance; ISO 105-X12 and ISO 105-B02 for color fastness for washing and for light, respectively; ISO 5077 for dimensional stability for shape loss after washing; ASTM D3884/D3884M for abrasion resistance; and AS/NZS 4399:2017 for UV protection.

However, this is not intended as a limitation on the scope of the present disclosure. As a person of skill in the art will appreciate, outer layer 306, and bottom layer 412 portions may be made of the same or varying materials having different characteristics. For example, outer layer 306 may be made of ballistic polyester using a denier filament yarn type, while top layer 404 or bottom layer 412 may be made of e.g., 100% polyester using a jersey knit filament yarn type. Similarly, outer layer 306 may have a weight specification of, e.g., 450 GSM, that is different from that of top layer 404 or bottom layer 412, which may have a weight specification of, e.g., 150 GSM. In embodiments, a moisture-wicking, antimicrobial finish may be applied to sound dampening sleeve assembly 300.

In operation, in embodiments, sound dampening sleeve assembly 300 may be removably affixed to a common punching bag, such as that shown in FIG. 1, having an outer layer made of vinyl that would normally serve as a target area for a punch or a kick, such that inner layer 302 of sleeve assembly 300 is in contact with the outer layer 102, and outer layer 306 in FIG. 3 now serves as the target area.

In embodiments, once outer layer 306 is struck by an external force, filler material 304, which is in contact with outer layer 306, may act like a like thick blanket in that it not only absorbs kinetic energy but also significantly dampens the audible sound that would otherwise result from striking a target area on outer layer 306.

In embodiments, to provide further noise reduction, outer layer 102 that is typically made of vinyl may be replaced with a fibrous material, such as knit or woven cotton or any other chemical or natural fibers and any combination thereof.

In embodiments, sound dampening sleeve assembly 300 may be made removable, washable, and easily replaceable by employing one or more zippers, e.g., on bottom layer 412 that, in embodiments, ensure that sleeve assembly 300 wraps tightly around the outer layer 102 of punching bag 100. Sleeve assembly 300 may further be tightened to the bottom of top portion 102 and 202 of respective punching bags 100 and 200 using any tightening method known in the art, such as Velcro®.

It is understood that any other element and mechanism may be used to at least partially enclose or encapsulate punching bag 100, 200. It is further understood that the exposed surface of outer layer 306 may comprise decorative, aesthetical, and/or informational features, such as labeling and other markings. As one of skill in the art will appreciate, advantageously, existing punching bags, such as that shown in FIG. 1, may be retrofitted with sound dampening sleeve assemblies according to various embodiments discussed herein.

In addition, in embodiments, for example, for users that prefer punching bags that produce a relatively loud sound upon impact, but still prefer the ability to wash and/or replace the target surface, i.e., outer layer 102 with a fabric material according to various embodiments herein, e.g., for aesthetic reasons, sleeve assembly 300 may be replaced with an outer layer 302 that is constructed from of non-fabric material, e.g., vinyl material.

In such embodiments, unlike existing vinyl punching bags, top portion 202 shown in FIG. 2 may comprise a non-vinyl outer layer that is suitable for vacuum sealing, which, advantageously, reduces shipping and handling costs, and sleeve assembly 300 having, e.g., a vinyl or leather outer layer may be placed over the non-vinyl outer layer, e.g., by the end user, without the need for using inner layer 302 or filler material 304 shown in FIG. 3.

It is understood that sound dampening sleeve assembly 300 illustrated in respective FIG. 3 is not limited to the constructional detail shown there or described in the accompanying text. As those skilled in the art will appreciate, components may be combined in various configurations. Further, sleeve assembly 300 may comprise any combination of components not expressly mentioned herein, such as fasteners and other components helpful in accomplishing the objectives of the present disclosure. Furthermore, other geometries and materials having suitable mechanical properties may be used to implement the teachings of the present disclosure without departing from the spirit of the invention.

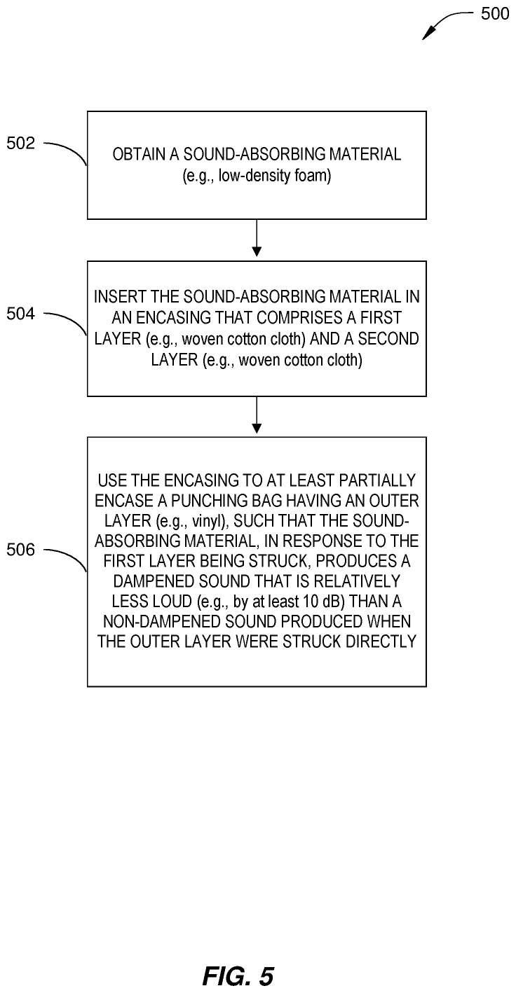

FIG. 5 is a flowchart of an illustrative process for making a sound dampening sleeve assembly in accordance with various embodiments of the present disclosure. In embodiments, process 500 for making a sound dampening sleeve assembly may start when, at step 502, a sound-absorbing material, such as a low-density fleece, padding or foam material, is obtained. At step 504, the sound-absorbing material is inserted in an encasing that comprises a first layer and a second layer. Finally, at step 506, the encasing is used to at least partially encase a punching bag that has an outer layer. In embodiments, in response to the first layer being struck, such the sound-absorbing material produces a dampened sound that is relatively less loud (e.g., by at least 10 dB) than a non-dampened sound that is produced when the outer layer is directly struck without the sound-absorbing material.

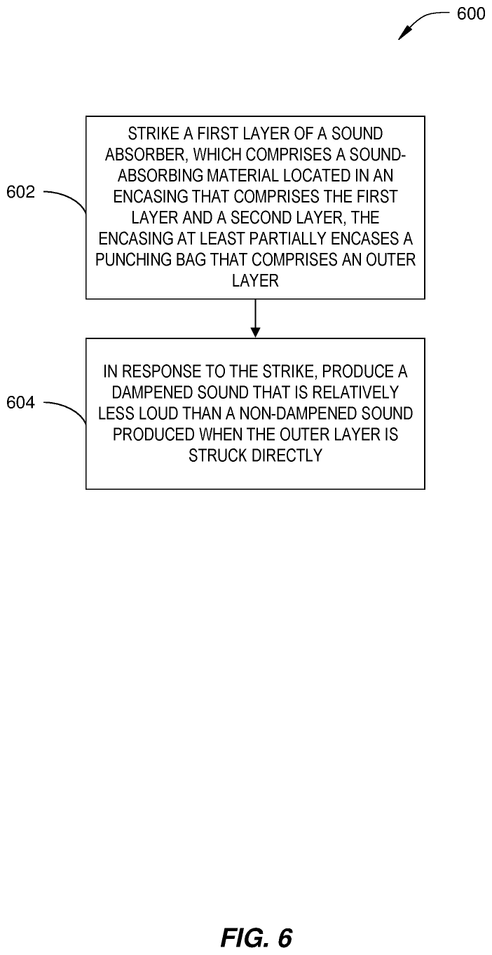

FIG. 6 is a flowchart of an illustrative process for using a sound dampening sleeve assembly in accordance with various embodiments of the present disclosure. In embodiments, process 600 for using a sound dampening sleeve assembly may start when, at step 602, a first layer of a sound-absorber that comprises a sound-absorbing material, such as a low-density fleece, padding or foam material, is struck. The sound-absorbing material may be located in an encasing that comprises the first layer and a second layer. In embodiments, the encasing at least partially encases a punching bag that comprises an outer layer. At step 604, the strike may be used to produce a dampened sound that is relatively less loud than a non-dampened sound that is produced when the outer layer is struck directly.

One skilled in the art will recognize no computing system or programming language is critical to the practice of the present invention. It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for making a sound absorber for a punching bag, the method comprising:
obtaining a sound-absorbing material;
inserting the sound-absorbing material in an encasing that comprises a first layer and a second layer, the second layer comprising a top edge and a bottom edge that are located at opposite ends of the second layer, the encasing further comprising at least one of an air gap or a sound absorbing layer; and
placing the encasing in contact with an outer layer of a punching bag such that the sound-absorbing material, in response to the first layer being struck, produces a dampened sound that is relatively less loud than a non-dampened sound that is produced when the outer layer is struck directly.

2. The method according to claim 1, wherein sound-absorbing material provides a decibel reduction of at least 10 dB when struck by an external force.

3. The method according to claim 1, wherein the first layer is an inner layer and the second layer is an outer layer that both are substantially parallel to each other.

4. The method according to claim 1, wherein the encasing further comprises a top layer and a bottom layer that are affixed by seams, along their edges, to the respective top edge and bottom edge of the first layer.

5. The method according to claim 1, further using the encasing to at least partially encircle a punching bag such that the top layer and the bottom layer are substantially parallel to each other.

6. The method according to claim 1, wherein the sound-absorbing material comprises a knit or woven fabric.

7. The method according to claim 1, wherein the fabric comprises a combination of chemical and natural fibers.

8. The method according to claim 1, wherein encasing completely encases the sound-absorbing material.

9. The method according to claim 8, wherein the sound-absorbing material is substantially evenly distributed within the encasing.

10. The method according to claim 1, wherein the encasing comprises a zipper along the bottom layer.

11. A sound absorber comprising:
a sound-absorbing material; and
an encasing comprising a first layer and a second layer that encase the sound-absorbing material, the first layer comprising:
a top edge and a bottom edge that are located at opposite ends of the first layer,
wherein the encasing, in response to being placed in contact with an outer layer of a punching bag and in response to the first layer being struck, causes the sound-absorbing material to produce a dampened sound that is relatively less loud than a sound produced when the outer layer is struck directly.

12. The sound absorber according to claim 11, wherein the encasing comprises a zipper along the bottom layer.

13. The sound absorber according to claim 11, encasing completely encases the sound-absorbing material.

14. The sound absorber according to claim 13, wherein the sound-absorbing material is substantially evenly distributed within the encasing.

15. The sound absorber according to claim 11, wherein the first layer is an outer layer and the second layer is an inner layer that both are substantially parallel to each other.

16. The sound absorber according to claim 15, wherein the encasing further comprises a top layer and a bottom layer that are substantially parallel to each other and affixed by seams, along their edges, to the respective top edge and bottom edge of the first layer.

17. The sound absorber according to claim 11, wherein the sound-absorbing material comprises a knit or woven fabric.

18. The sound absorber according to claim 11, wherein the fabric comprises a combination of chemical and natural fibers.

19. The sound absorber according to claim 11, wherein, in response to the encasing at least partially encircling a punching bag, the top layer and the bottom layer are substantially parallel to each other.

20. A method for using a sound absorber for a punching bag, the method comprising:
striking a first layer of a sound absorber that comprises a sound-absorbing material located in an encasing that comprises the first layer and a second layer, the encasing at least partially encases a punching bag that comprises an outer layer; and
using the strike to produce a dampened sound that is relatively less loud than a non-dampened sound that is produced when the outer layer is struck directly.
